(19) United States
(12) Patent Application Publication
(10) Pub. No.: US 2007/0239625 A1
(43) Pub. Date: Oct. 11, 2007

(54) System and method for providing access to language interpretation

(75) Inventors: THOMAS STERNS, PACIFIC GROVE, CA (US); PHILIP S. SPECIALE, MONTEREY, CA (US); GREGORY S. MARSHALL, PACIFIC GROVE, CA (US); LINDSAY M. D'PENHA, MONTEREY, CA (US)

Correspondence Address: PATENT INGENUITY, PC, 520 BROADWAY, SUITE 350, SANTA MONICA, CA, 90401, US

(73) Assignee: LANGUAGE LINE SERVICES, INC., MONTEREY, CA (US)

(21) Appl. No.: 11/278,784

(22) Filed: Apr. 5, 2006

(51) Int. Cl. G06F 17/00; G06G 7/00

(52) U.S. Cl. 705/400

(57) ABSTRACT

In one aspect, there is a method of providing a language interpretation service. A request for language interpretation service can be received from a user at a computing device. The user speaks a first language. A user identifier that is associated to the user is generated. Additionally, the user identifier is transmitted to the computing device. The user identifier permits access to language interpretation service. The user identifier can be stored in a user database. A language access number can also be provided. The language access number can be a toll-free number. The language access number can be used to place a voice call to a language interpretation service provider for language interpretation assistance. A voice call from the user is received. The user places the voice call by dialing the language access number. Finally, language interpretation service is provided to the user if the user provides the user identifier. The language interpretation service interprets between the first language and a second language.

### BACKGROUND

1. Field of the Technology

The present invention relates generally to offering language interpretation services. More specifically, the present invention relates to providing language interpretation services to users who subscribe through a computer network such as the Internet.

2. Description of the Background Art

As the world becomes more connected through air travel, high-speed data transfers, cellular communication networks and integrated business solutions across countries via the Internet, multilingual communication has become more prevalent. Travelers, business professionals and companies communicate in multiple languages and require immediate access to interpretation services. For example, many travelers find that a major obstacle in traveling abroad is communicating in those countries where they do not speak the native language. Previous attempts have been made to provide interpretation services to travelers; however, such services are not always convenient. Many people purchase foreign language dictionaries for the purpose of interpretation when traveling abroad. This approach, though, is inevitably awkward in attempting a conversation and quite time-consuming to use. Electronic devices are also available that offer interpretation based on what is typed on a small keyboard. This, too, can be time-consuming and is far from convenient. In addition, translation devices and dictionaries add to the daily load that the traveler must carry during the trip. Without immediate access to language interpretation services, many business negotiations can become stagnant or be entirely disrupted.

### SUMMARY

In one aspect, there is a method of providing a language interpretation service. A request for language interpretation service can be received from a user at a computing device. The user speaks a first language. A user identifier that is associated to the user is generated. Additionally, the user identifier is transmitted to the computing device. The user identifier permits access to language interpretation service. The user identifier can be stored in a user database. A language access number can also be provided. The language access number can be a toll-free number. The language access number can be used to place a voice call to a language interpretation service provider for language interpretation assistance. A voice call from the user is received. The user places the voice call by dialing the language access number. Finally, language interpretation service is provided to the user if the user provides the user identifier. The language interpretation service interprets between the first language and a second language.

In a further aspect of the method, a total amount of money for the language interpretation service can be charged to the user. In one embodiment, the total amount of money is charged to a credit card of the user. In another embodiment, the total amount of money charged is based on a per-minute fee.

In a further aspect, the request for language interpretation service includes user payment information. The user payment information can include user credit card information. Moreover, the request for language interpretation service can include user personal information. User personal information can include, for example, user preferences.

In the method, the request for language interpretation can be received at a registration server communicably coupled with the computing device through a computer network. The computer network can be the Internet. The registration server can be a web server that hosts a web page for entering data. Alternatively, the request can be received by a live operator.

Moreover, the user identifier can be associated with a user profile. The user profile may include user preferences. Furthermore, user preferences include the language spoken by the user. Also, user preferences can include the language to be translated.

In a further aspect of the method, an interpreter that can translate between the first language and a second language can be identified. The first language can be English, Spanish, German, French or Chinese. The second language can be English, Spanish, German, or French or Chinese. Language interpretation can be provided to the user by engaging an interpreter in the voice call with the user. The voice call can be first received by a private branch exchange that routes the voice call to the interpreter, the interpreter being located remotely from the business facilities of the language interpretation service provider.

In another aspect of the method, the type of business need of the user is identified. A business merchant that can address the business need of the user can be further identified. The can be a bank, a health care provider, a government entity, an airline, a rental car agency, a hotel, a travel agency, an amusement park, a resort, a casino, a cruise line, a public transportation agency, a financial company, an insurance company, or a telecommunications company.

In another aspect, there is a system of providing a language interpretation service. The system comprises a web server, a private branch exchange, and a validation module. The web server receives from a user at a computing device a request for language interpretation service. The web server can be configured to transmit a user identifier to the computing device. The user identifier permits access to language interpretation service. The private branch exchange receives a voice call from the user. The user places the voice call by dialing a language access number. The voice call is made to a language interpretation service provider to receive language interpretation service. The validation module validates the user identifier. If the validation module validates the user identifier, the language interpretation service interprets between the user's language and an interpreted language.

In a further aspect of the system, a user database can be included to store the user identifier. In addition, the system can further comprise an accounting module that charges a total amount of money for the language interpretation service to the user. The total amount of money can be charged to a credit card of the user. Alternatively, the total amount of money charged is based on a per-minute fee.

As such, the request for language interpretation service can include user payment information. The user payment information can include user credit card information. The request for language interpretation service can include user personal information. The user personal information can include user preferences.

### DRAWINGS

By way of example, reference will now be made to the accompanying drawings.

FIG. 1 illustrates a component diagram of a system for providing language interpretation services.

FIG. 2 illustrates a component diagram of a system for providing language interpretation services via the Internet.

FIG. 3 illustrates a flow diagram for a process to handle a customer request for language interpretation service.

FIG. 4 illustrates a flow diagram for a process to handle a customer request for language interpretation service and receive payment.

FIG. 5 illustrates a screenshot of a user interface for requesting language interpretation service.

FIG. 6 illustrates a screenshot of a user interface for providing a user information regarding access to language interpretation service.

FIG. 7 illustrates a component diagram of a system for providing language interpretation services between a customer and a merchant.

FIG. 8 illustrates a component diagram of a system for providing language interpretation services wherein a user calls the listing service provider using the Internet.

FIG. 9 illustrates a component diagram of a system for providing language interpretation services wherein an interpreter of the language interpretation provider is connected through the Internet.

FIG. 10 illustrates a component diagram of a system for providing language interpretation services wherein the user is referred to the website of the language interpretation provider by a third party.

### DETAILED DESCRIPTION

A method and system of offering immediate access to language interpretation service is disclosed. The system and method of the present invention allows for access to live interpretation services anywhere in the world. Specifically, the method involves providing over the telephone interpretation services to a user such as a traveler or business professional who registers for language interpretation service through a Web site provided by the language interpretation provider. The user can provide a method of payment such that the user is only charged for the costs actually incurred. Therefore, the payment can follow a pay-as-you-go model. Once the user registers, the user can be provided with a unique user identifier that is used every time the user utilizes the language interpretation service.

Quality, live, professional language interpretation, as disclosed herein, can turn a barely discernable communication into a clearly understood conversation between people speaking different languages. Therefore, the user who registers for language interpretation service is provided with the assurance of instant language assistance from anywhere in the world at any time of the day. The language interpretation service can be available in over one hundred and fifty languages.

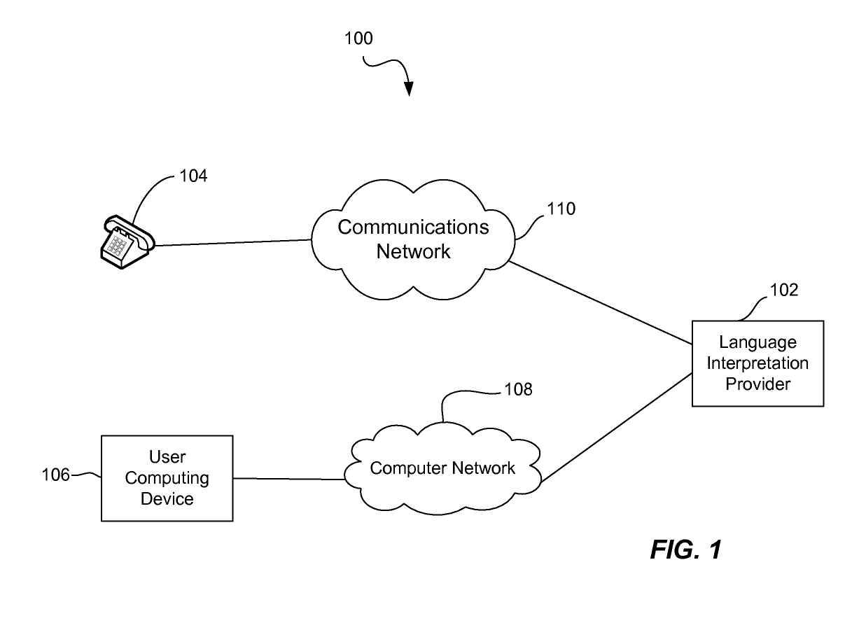

FIG. 1 illustrates a component diagram of a system for providing language interpretation services. A user can utilize a user computing device 106 and connect through a computer network 108 to the language interpretation provider. The user can request language interpretation service though the user computing device 106 and communicate such request to the language interpretation provider 102. The computing device 106 can be a personal data assistant, a personal computer, a laptop computer, handheld device, a cellular telephone and the like. Once the request is received, the language interpretation provider 102 can assign a unique user identifier to the user. The user can subsequently call the language interpretation provider 102 using a telephonic device 104. The telephonic device 104 can connect to the language interpretation provider 102 through a communications network 110. In one embodiment, the communications network 11 is a public telephonic network. Once the user is connected to the language interpretation provider 102, the user can utilize the user identifier in order to be authenticated by the language interpretation provider 102.

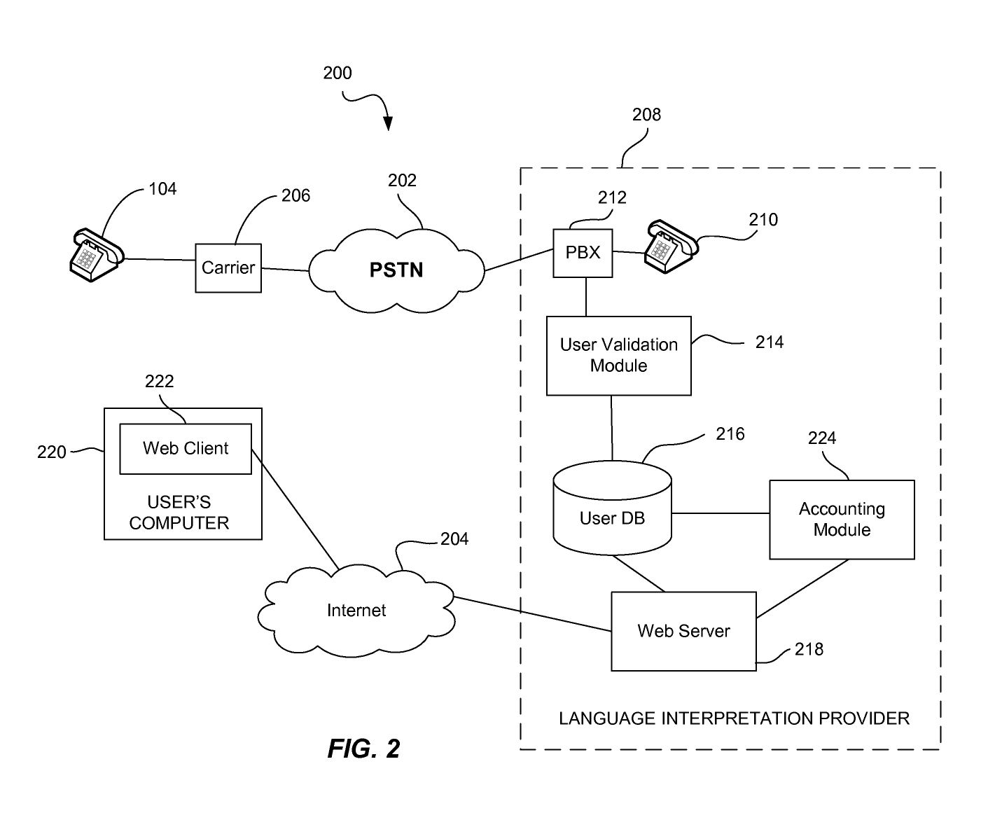

FIG. 2 illustrates a component diagram of a system for providing language interpretation services via the Internet. A user can utilize the user's computer 220 to connect to the Internet 204. In one embodiment, the user utilizes a Web browser 222 that resides in the user computer 220. The Web browser 222 connects to the Internet 204 and communicates with a Web server 218 provided by the listing service provider 208. At the user's computer 220, the user can interact with a Web browser to request language interpretation service. The listing service provider 208 can provider a Web site through which the user makes a request for a language interpretation provider. Thus, for example, travelers and business professionals around the world having Internet access, can request live language interpretation through the Web site hosted by the Web server 218. Internet access locations, such as Internet cafes, Internet hotspots, and the like are pervasive in many countries and cities of the world. Users here can access the Internet and easily register for language interpretation service.

Once a user registers, the user can be provided with a unique user identifier associated to the user. The user identifier is stored by the Web server 218 in a user database 216. In one embodiment, the user database 216 is a relational database. The user can then utilize the telephonic device 104 to call the listing service provider 208. In one embodiment, the telephonic device 104 is subscribed to a communications carrier 206 which routes the call to the public telephonic network 202, and to a private branch exchange 212. The private branch exchange 212 can be part of the communication infrastructure of the language interpretation service 208. In one embodiment, the call received from the user at the private branch exchange 212 can be handled by a voice recognition system (not shown). The voice recognition system can prompt the user to provide the user identifier. In one example, the voice recognition system interacts with the user in the local language. In another example, the voice recognition system can recognize that type of language spoken by the user. The voice recognition system relays the user identifier provided to the user for a user validation module 214. The user validation module 214 comprises logic to compare the provided user identifier with valid user identifiers stored in the user database 216. Once there is a match, the user is provided with language interpretation service. If the user identifier provided by the user does not match any of the user identifiers in the user database 216, the user is prompted for the user identifier again.

In another embodiment, the call received from the user at the private branch exchange 212 can be handled by an operator. The operator can prompt the user to provide the user identifier. In one example, the operator system interacts with the user in the local language. The operator relays the user identifier provided to the user for a user validation module 214. For example, the operator can be provided with a personal computer having input and output functions and the user validation module 214 residing therein. The operator can then type in the user identifier provided by the caller to validate the user. The user validation module 214 can comprise logic to compare the provided user identifier with valid user identifiers stored in the user database 216. Once there is a match, the user is provided with language interpretation service. If the user identifier provided by the caller does not match any of the user identifiers in the user database 216, the caller is prompted for the user identifier again.

If the user is validated and there is a match of the provided user identifier with one of the user identifiers residing in the user database 216, the user is connected with an interpreter 201 at telephonic device 210. In one embodiment, the interpreter 201 is directly connected to the private branch exchange 212. In another embodiment, the interpreter 201 at the telephonic device 210 is connected remotely from the private branch exchange 212.

In yet another embodiment, an accounting module 224 can be provided within the language interpretation provided infrastructure. The accounting module can be a standalone computer or server, or a process in a web server or another server. The accounting module 224 can be configured to with logic to calculate correct billing charges to payment accounts provided by the user. Billing can be incurred on a per-minute basis, on a per-call basis, or a monthly basis, etc.

In one example, a business professional is provided with a company credit card. If the business professional needs interpretation services for company purposes, the business professional can log into the service provider Web site and the Web browser 222 and register for language interpretation service. The business professional can register for a language interpretation prior to departure on a trip or at the point of arrival. The user identifier provided to the business person can be associated to a telephone number such that the business person can call the telephone number which allows the business professional access to language interpretation services over the telephone from anywhere in the world. The telephone number associated with the user identifier is preferably a toll-free international number or a series of international toll-free numbers compatible with countries around the world. In another example, a parent gives a child or teenager an authorized credit card for charging in cases of emergency. If the child or teenager needs interpretation services, the child or teenager can log into the service provider Web site and the Web browser 222 and register for language interpretation service.

In yet another embodiment, travel agents and/or travel-related companies can provide travelers, clients and/or employees with a pin number that charges to a specific deposit account, charge account, or debit account. The travel agents or any entity registering for the language interpretation service can register at the Web site provided by the language interpretation provider. The user identifier can be provided to the traveler or included as part of a travel package by their travel agent. This amenity can be offered by airlines, travel agencies, car rental companies and travel insurance agents, as peace of mind to those planning travel abroad.

The user identifier can additionally be obtained by the traveler, such as in a commercial computer at an airport or another related location, like a hotel, tourist attraction or just about any other convenient location. The user identifier is, therefore, unique to the user and payment reflects actual usage, being automatically paid by credit card or debit user identifier in accordance with the activation setup executed by the user.

Providing a separate methodology, such as a credit card payment methodology, enables immediate access to over-the-phone language interpretation services while avoiding integration issues with telecom or wireless carriers. Using credit card payment methodology, international wireless and telecom companies are thus removed from the process of billing the user. Telecommunication companies are relieved from having to integrate interpretation billing systems and functionality onto their systems and platforms. This credit card payment approach enables the user/client to assess new opportunities without the capital outlay or integration issues that have long been barriers to the industry to date.

Another embodiment of the user identifier is for alternative payment methods in which to access interpretation, whether domestically or internationally. In one embodiment an online wallet is used a method of payment. In another embodiment, a bank account is used for debiting money for the language interpretation usage. In another embodiment, PayPal is used.

An additional application is for business or personal clients seeking to calculate and/or limit their spending of Over-the-Phone Interpretation (OPI) services. Use of user identifier formats limits use to the amount of time loaded or authorized, thereby making the user identifier a valuable cost containment tool. Therefore, in one embodiment, a credit card with a daily limit of spending can be utilized. In another embodiment, a credit card with a total limit of spending can be utilized.

Applications for non-travelers seeking interpreter 201s for communication purposes whether abroad or at home are also within the scope of the disclosure. The same application holds true for domestic interpretation, assisting non-English speaking residents to communicate in English-speaking countries, i.e., native Spanish-speaking residents seeking a communication tool for use within the United States. This holds true for all language-based solutions in any country delivered through the convenience of user identifier access.

Further, commercial applications have been identified in military, legal, healthcare and emergency services environments where authorized access to interpretation services must be obtained immediately. It is, therefore, an object of the present disclosure to provide a method for providing interpretation services to users generally, for instance, travelers and business professionals that is both convenient and significantly can be accessed in a very short time.

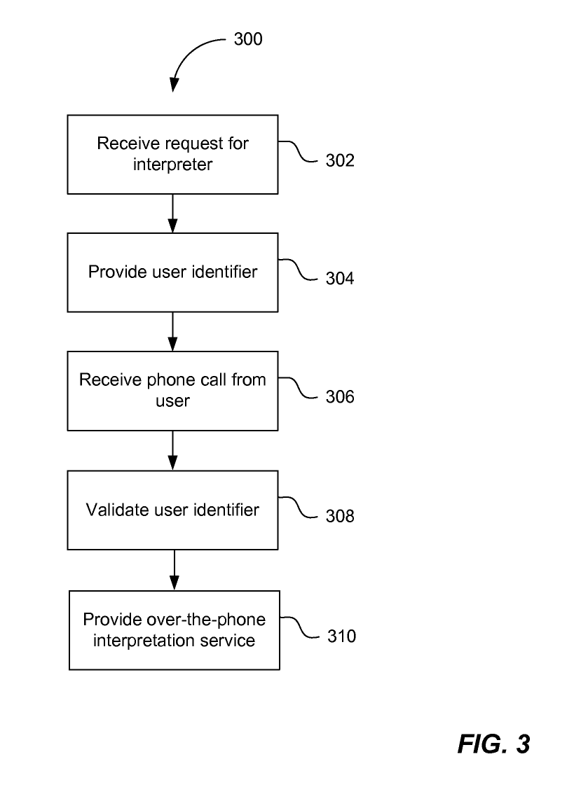

FIG. 3 illustrates a flow diagram for a process 300 to service a customer request for language interpretation service. The process 300 starts at process block 302. At process block 302, a request for an interpreter 201 is received. The request can be entered by the user at a Web browser 222. Further, the request can be entered through a Web page hosted by a Web server 218. The process 300 then continues to process block 304.

At process block 304, a user identifier is provided. The user identifier can be provided through various communications mediums. In one embodiment, the user identifier is provided through an email. In another embodiment, the user identifier is provided through SMS. In another embodiment, the user identifier is provided through MMS. In yet another embodiment, the user identifier is provided using HTML in a Web page. Once the user is provided with the user identifier, the user identifier can be stored in the user database 216. The process 300 then continues to process block 306.

At process block 306, a voice call (e.g., telephone call) is received from a user. The user can place a voice call using an assigned toll-free number. In another embodiment, the user can place a voice call using a number that charges the voice call costs to a payment method provided by the user. In another embodiment, the user makes a data call (e.g., voice-over IP or Internet Protocol). Depending on the origin of the voice call, the call can be answered in the local language. In another embodiment, a voice recognition system answers the voice call and determines the language spoken by the caller. The process 300 then continues to process block 308.

At process block 308, the user identifier is validated. The user is requested to input or provide the user identifier. In one embodiment, the user is validated by user validation module 214. The user validation module 214 compares the user identifier with valid user identifiers stored at the user database 216.

In one example, the user identifier can be validated by a speech recognition software and comparative logic. In another embodiment, the user is requested to enter the user identifier through a pulse dial system. In another embodiment, the user is automatically identified if the user calls from the telephone number used at the time of registration. The process 300 then continues to process block 310.

At process block 310, over-the-phone interpretation is provided. The interpretation can be for a voice call that occurs with regard to a two-way call or a three-way call. In one embodiment, interpretation is provided in a conversation between the user and a third party. In another embodiment, the user can simply call the interpretation service to inquire how to express an idea, or simply pronounce a word. In another embodiment, the user can ask the interpreter 201 to be connected with a specific service.

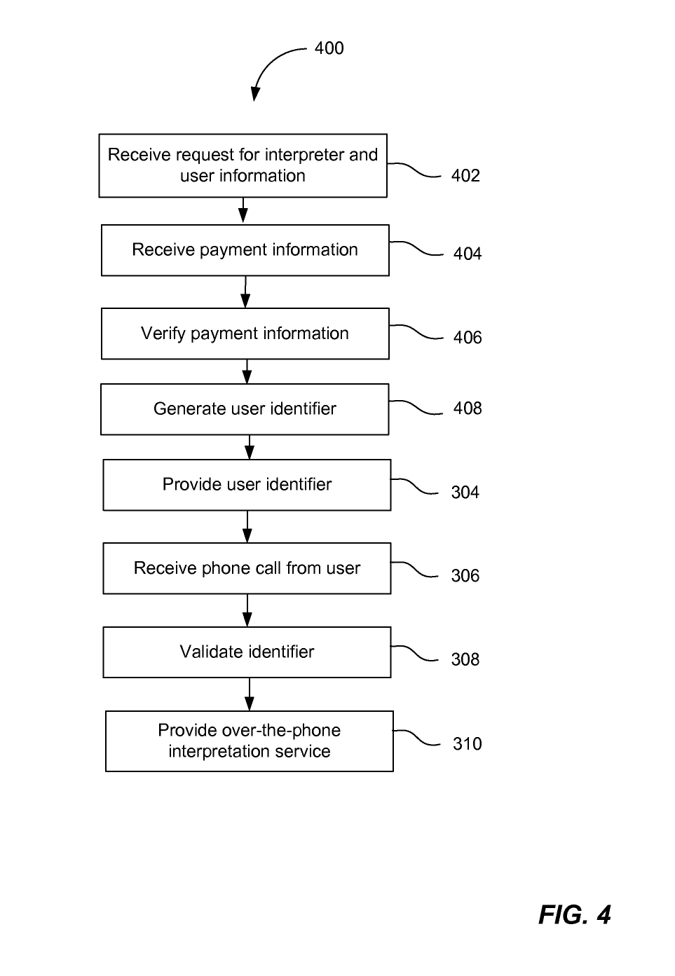

FIG. 4 illustrates a flow diagram for a process 400 to handle a customer request for language interpretation service and receive payment. As such, FIG. 4 reflects another embodiment wherein a payment method is provided by the user.

At process block 402, a registration request is received. The registration request can include user personal information. In addition, the registration request can include the language preference of the user. For example, the user can speak Spanish, and so indicate that the user speaks Spanish when registering. Accordingly, when the user later makes a voice call (e.g., telephone call) to the listing service provider 208 and the user identifier is validated, the language of preference can be used for connecting to an interpreter 201 that speaks the language indicated by the user preference.

In another embodiment, the user identifier has an associated user profile that is also stored in user database 216. The user profile can include a field for the language preference. Furthermore, the user profile can include the name, address, telephone, payment information, activities and other related personalized information.

The process 400 then continues to process block 404. At process block 404, payment information is received. Payment information can, for example, comprise credit card information such as credit card number, expiration date and security code. In another embodiment, payment information can comprise bank information including routing number and account number. The process 400 then continues to process block 406.

At process block 406, payment information is verified. Verification of the payment information can be done immediately or after a period of time. Known verification methods of credit card can be utilized. For example, a request for validation of a credit card number can be submitted to the credit card company over a communications network. In another embodiment, where the payment information provided is a bank account to be debited, the verification method can include submitting a validation request to the bank or financial institution in which the account resides.

In addition, once the payment information is verified, the payment information can be stored in the user profile. For example, the credit card information can be stored in the user profile. In another embodiment, the billing address and social security number of the user can be stored in the user profile. In yet another embodiment, bank information can be stored in the user profile. In yet another embodiment, user account information related to an online payment processor such as PayPal, MoneyBrokers, etc., can be stored in the user profile. In a further embodiment, the process 400 continues to process block 408 only if the payment information is verified.

At process block 408, a user identifier is generated. In one embodiment, the user identifier can be randomly generated by the language interpretation provider 208. In another embodiment, the user identifier is generated in sequential order.

The process 400 then continues to process block 304. As discussed above, at process block 304, a user identifier is provided. At process block 306, a voice call is received from the user. At process block 308, the user identifier is validated. At process block 310, over-the-phone interpretation is provided once the user identifier is deemed valid.

In one embodiment, once the interpretation service is provided by the language interpretation provider 208 and the user disconnects from the call, the number of minutes is calculated and then utilized to calculate the total amount of money to be charged to the payment account provided by the user.

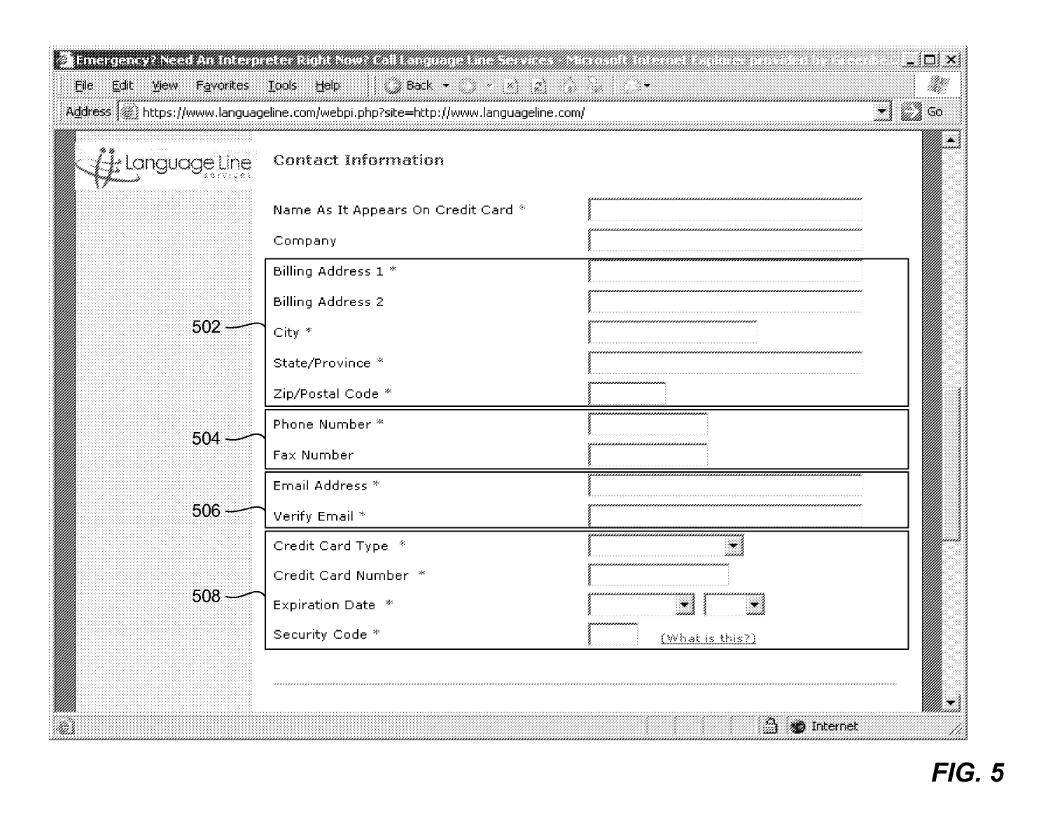

FIG. 5 illustrates a screenshot of a user interface for requesting language interpretation service. A Web site provided by the language interpretation provider 208 can reside at the Web server 218. The Web site can include a data entry form wherein a user can input user-specific information to register for language interpretation service. Thus, for example a traveler, business professional, or any other individual so inclined and in need can access the data entry form 500 from anywhere in the world through a user computing device 114. The Web browser 222 displays multiple data entry fields such as address fields 502, contact number fields 504, email fields 506, and payment information fields 508. Upon entering the information in these fields, the user data entered can be verified for accuracy and correctness. For example, the ZIP code, email address, and other verifiable data can be processed to ensure that only valid data is received in association with a new user. Once personal data is verified, the new user can be provided with an individual, unique user identifier.

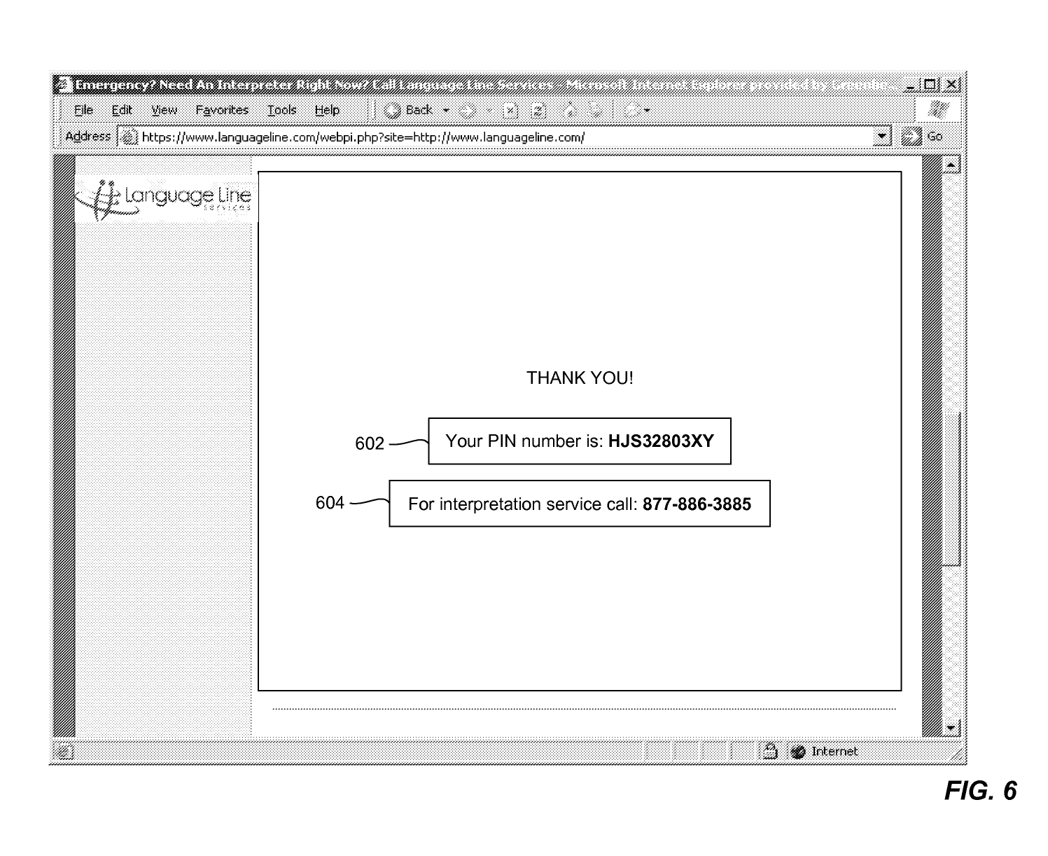

FIG. 6 illustrates a screenshot of a user interface for providing a user with information regarding access to language interpretation service. A user identifier 602, such as a personal identification number (PIN), can be provided to a user who registers for language interpretation service. In one embodiment, the user identifier 602 is provided by sending an email to the user. In another embodiment, the user identifier 602 is provided in a hypertext Web page following the validation of payment information. In another embodiment, the user identifier 602 can be delivered to a wireless device carried by the user.

In addition, a telephone number or other access mechanism to a language interpretation service 208 is provided. For example, a toll-free number can be provided that gives access to an operator for the language interpretation service 208. In another example, a link for dialing through the user computing device 114 can be provided such that a telephonic call is made through the computing device by using a modem interface. In another example, the link for dialing through the user computer device can be provided such that a voice-over-IP connection can be established with the language interpretation service. In another embodiment, the telephone number provided can be associated with the same language spoken by the user such that when the user calls an operator speaking the user's language answers. For example, a user speaking Chinese can register as a Mandarin Chinese speaking customer. The customer can be provided with a toll-free number dedicated Chinese customers speaking Mandarin Chinese. If the user calls that number, an operator speaking Mandarin Chinese answers the call. Thus, the user identifier can be language-specific, and the telephone number, itself, printed on the user identifier specific to a certain language.

In other embodiments, the telephone number offers a general language interpretation service, and the user must specify what language is desired during the call. Commercially, there is the advantage of offering to the user a user identifier by including this user identifier in a travel package customized with an air travel ticket, travel insurance, accident insurance, car rental and/or accommodations.

Furthermore, in another embodiment, the user identifier is a special combination user identifier to be used for either telephone services or the interpretation services or the interpretation services together with the telephone services.

In another form, the user identifier can be the same as the user's mobile telephone number or identifier. There can be a telephone number to call programmed into the telephone for speed dial connecting to obtain language interpretation services. The telephone number to call can be programmed into the telephone and be accessed by pressing a single button on the mobile telephone. The commercialization of the interpretation feature for the wireless carrier is the addition of the interpretation feature, to be integrated as the interpretation service onto their service platform. For example, a wireless provider feature is a pay-as-you-go model, and embedded into the format of the wireless service used by a wireless subscriber is the interpretation service. In some situations especially in the wireless telephone mode the interpretation service is available due to the prepaid user identifier, debit user identifier, or ongoing service access contracted in advance by the user and the wireless telephone company.

In another embodiment, the user can register for language interpretation services, such that the user identifier expires within a certain period of time. For example, if the user is traveling for two weeks, then the interpretation service is cut-off after two weeks. This feature can prevent unauthorized use of the interpretation service when the user no longer requires this. In addition, in another embodiment, the user may be provided with the option of returning to the language interpretation Web site and reactivate language interpretation service for another predetermined period of time, or indefinitely. Means for accessing the Web site can include a separate username and password combination, the same user identifier as that used for language interpretation services, or any other identifier.

In addition, the user can set up the account such that the interpreter 201 changes automatically depending on configuration by the user. For example, if the user is going to spend the first month in Germany, and the second month in Italy, then the user may customize the card such that during the first month, an interpreter 201 that speaks German and the user's language is immediately connected. In addition, the user may customize the interpretation account and the related user identifier such that on the second month an interpreter 201 that speaks Italian and the user's language is automatically connected.

In another embodiment, the Web site of the language interpretation service can allow a user to edit the user profile to change user preferences. For example, the preferred language of the user can be changed. Therefore, if a user travels to another country unexpectedly, the user can log into the account, change the languages of interpretation such that the appropriate interpreter 201 can be connected immediately.

Of course, if the user requires interpretation of another language, the user can indicate that to the current interpreter 201 and operator so that a new interpreter is connected.

If there is a sufficient amount of interpretation time available, or the user identifier has not expired, the user is essentially instantaneously connected to an interpreter 201 to provide essentially instantaneous interpretation services. The term “Essentially instantaneous” applies to a situation where a readily available bank of interpreter 201s established by a provider is on standby, wherein callers requesting interpretation services can be immediately or within less than thirty seconds connected to the selected interpreter 201 as soon as the validation has occurred such that the medium or data indicates time available and/or prepaid for that interpretation.

In one example, the language interpretation service provides the benefit of live interpreter 201s to English speaking individuals or others traveling abroad to foreign-language countries or to foreigners traveling to the United States. It can have many uses, for instance, emergency assistance, to aid in border, customs and immigration issues, assist in business communication for clarity, precision and etiquette, help clarify directions, or communicate with locals for any reason in their native language, and thus eliminate worry and risk for English-speaking travelers, among many others.

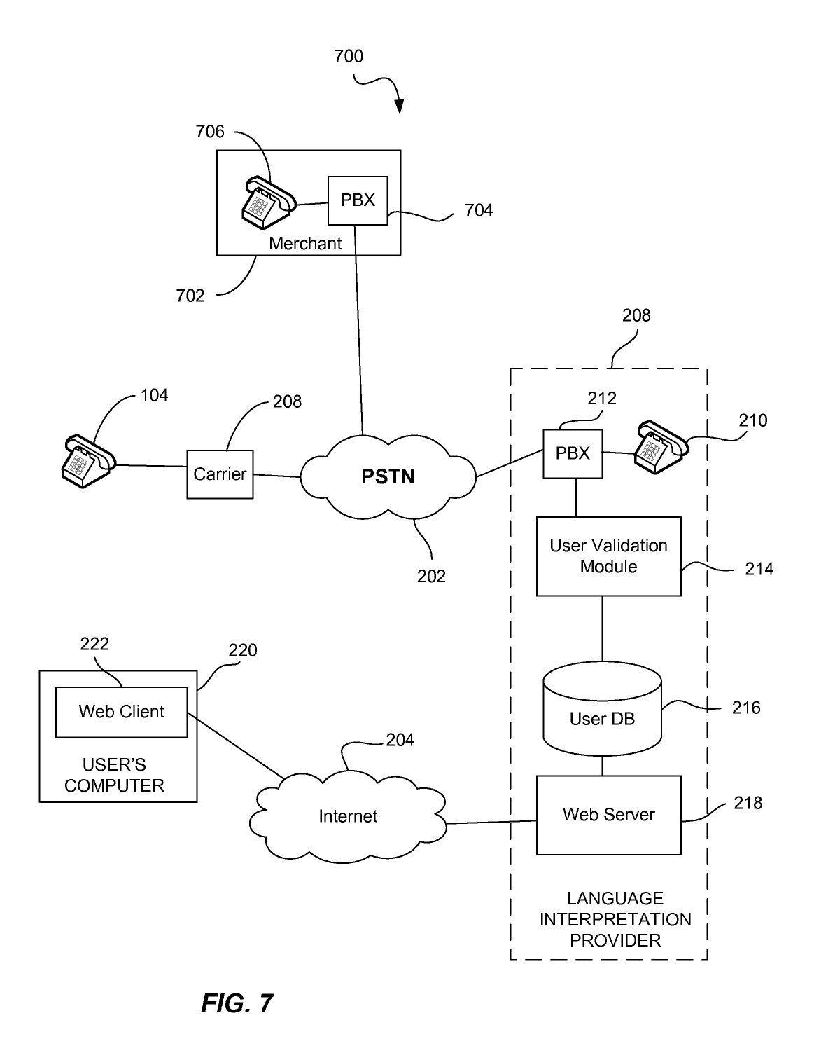

FIG. 7 illustrates a component diagram of a system for providing language interpretation services between a customer and a merchant 702. A user that subscribes to the language interpretation service can be connected to a merchant in order to resolve the business needs of the user. Once the user is connected to the language interpretation service, the interpreter 201 assists the user to determine the type of business need and/or service the user requires.

In one embodiment, the interpreter 201 assists the user to establish whether the user's business needs involve an emergency. In another embodiment, the interpreter 201 assists the user to transact business with a merchant 702. The interpreter 201 can then connect the voice call, through the public switch telephone network 110, to a customer service representative 134 of the merchant 702 through a corresponding private branch exchange 132. In another embodiment, the user does not have a business need but instead simply requests a service. In one embodiment, the interpreter 201 can make a voice call through an outgoing call telephonic module (not shown). The outgoing telephonic module permits the interpreter 201 to telephonically connect or engage an agent 706 representing the merchant 702.

The interpreter 201 can connect, in a three-way voice call, the user, the business entity or merchant, and the interpreter 201. The user can be connected with representatives of banks, hospitals, government agencies, companies, merchants, service providers, or any other public or private entity. The user can then conduct any transaction with the public or private entity with the assistance of the interpreter 201.

In addition, the method and system provided herein permit the user to conduct transactions with a second company or private or public entity. The transaction with the second company can be conducted in the same voice call once the first transaction has ended. Moreover, the same interpreter 201 who assists the user in the first voice call can assist the user in the second voice call.

In addition, the user profile can include business preferences, such that when the user registers and subscribes for interpretation service, the user indicates preferred service provider. For example, the user may indicate the preferred airline company for traveling, the preferred type of food, the preferred rental company, the preferred activities, etc., such that when the user is connected with an interpreter 201, the interpreter 201 has received the information and has connected the user with the stated preferred network of businesses.

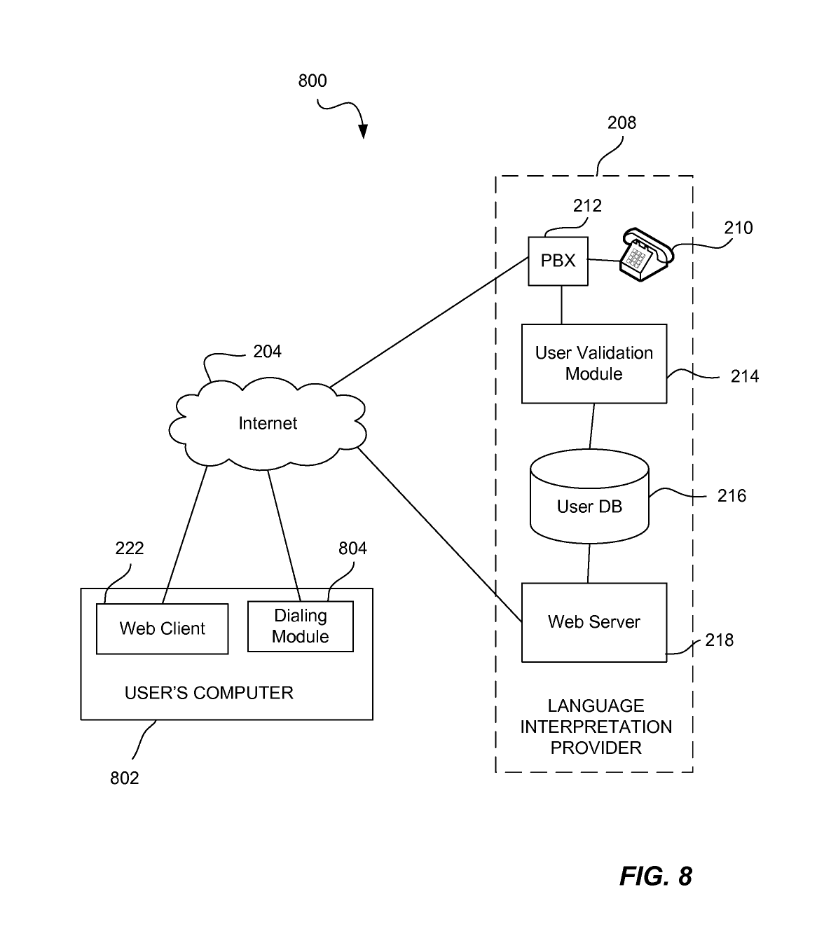

FIG. 8 illustrates a component diagram of a system for providing language interpretation services wherein a user calls the listing service provider using the Internet. In one embodiment, a user that registers and subscribes to the language interpretation service can make a voice call (e.g., telephone call) to the language interpretation service in order to receive interpretation assistance. In one embodiment, the user utilizes the same computing device as that for registrations. As such, immediately after registering and receiving a user identifier, through the Web browser 222, the user can make a voice call from the user's computer 802. The user's computer 802 can be configured with a dialing module 804 that permits the user to make voice calls to the language interpretation provider 208 directly from the user's computer 802. In one embodiment, the dialing module 804 utilizes an IP address to establish a voice call. In another embodiment, the dialing module 804 utilizes a telephone number to establish a voice call with the language interpretation provider. In yet another embodiment, the dialing module 804 can be configured to store a cookie that can later be sent to the language interpretation provider to validate the voice call.

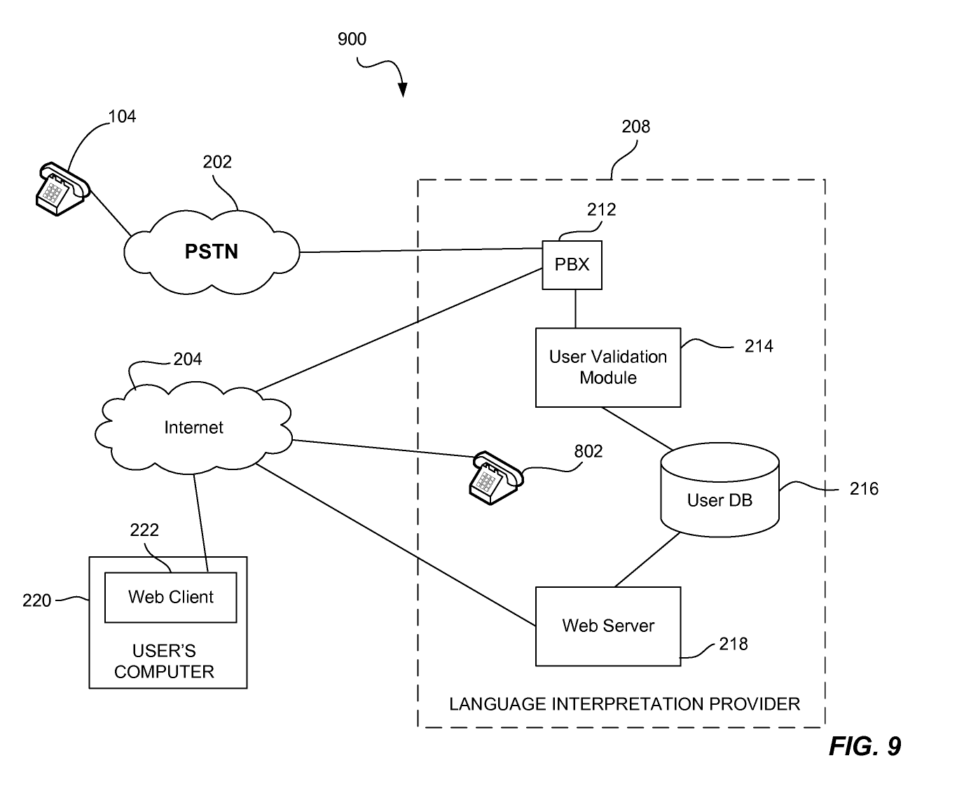

FIG. 9 illustrates a component diagram of a system for providing language interpretation services wherein an interpreter of the language interpretation provider is connected through the Internet. The language interpretation provider can employ interpreters to be on-site or off-site from the place of business of the language interpretation provider. As such, if the language interpretation provider is based in the United States, interpreters employed by the language interpretation can reside abroad, and be connected to the language interpretation provider through various communication networks. In one example, an interpreter can be connected to the language interpretation provider through the Internet 204.

Thus, once a user calls requesting interpretation services, interpreter 802 can be remotely connected through the Internet 204 or another communications network with the user. The user must first validate the subscription information using the user identifier. The validation information can be received from the user at the private branch exchange 212. In addition, the private branch exchange can interact with the user validation module 214 to validate the user identifier provided by the user. Once the user is validated, the private branch exchange 212 can route the call to the interpreter 802 via the Internet or another designated computer communications network. The voice call can be received by the interpreter 802 as a voice-over-IP call. In addition, user data can also be transmitted simultaneously to the interpreter 802 so that the interpreter 802 can better serve the user.

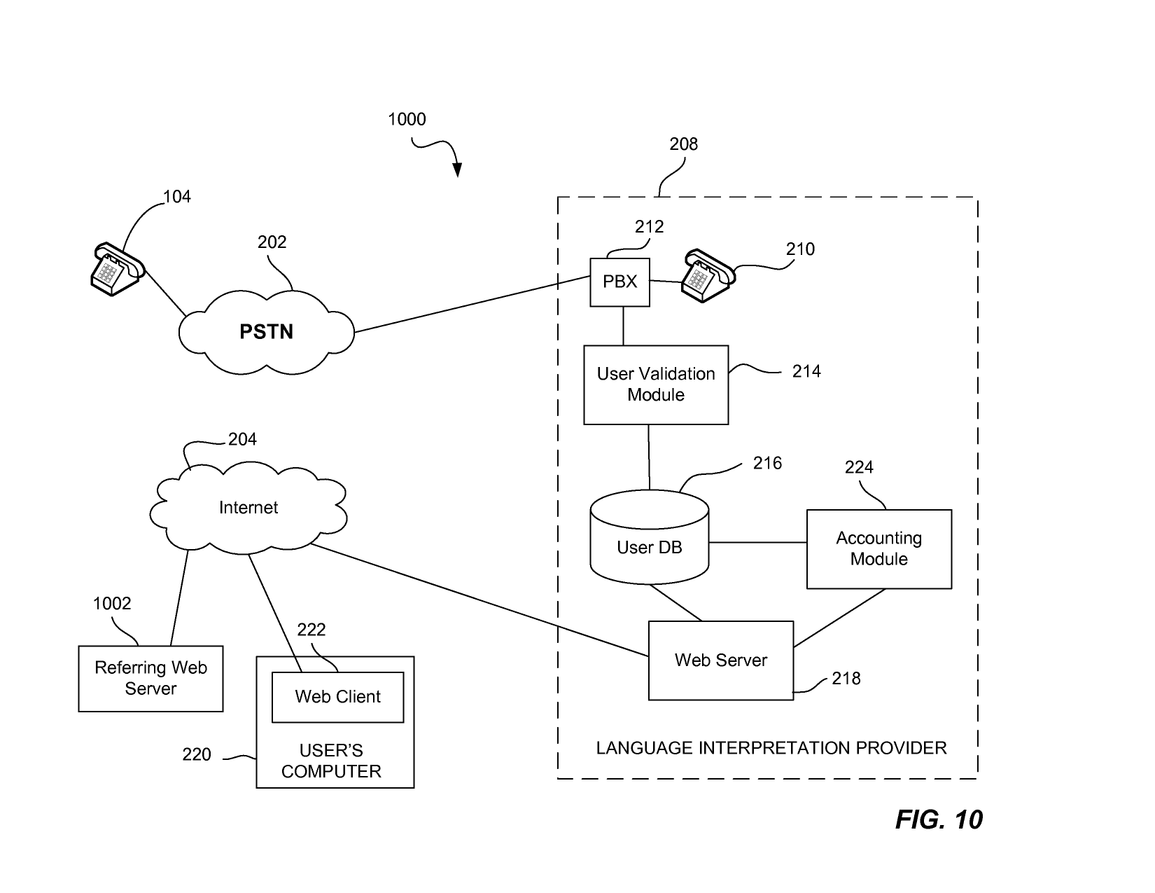

FIG. 10 illustrates a component diagram of a system for providing language interpretation services wherein the user is referred to the website of the language interpretation provider by a third party. In order to attract traffic to the website of the language interpretation provider 208, links and advertisement can be provided in third-party websites in order to encourage the user to access the website of the language interpretation provider 208.

For example, a website residing at a referring web server 1002 can include a hyperlink that references the registration website at the web server 218. The referring web server 1002 can be equipped with an affiliate code. Once the user selects the hyperlink referencing the web site of the language interpretation provider 208, the affiliate code can be transmitted to the web server 218. In turn, the web server 218 may associate the affiliate code with the user identifier so as to provide the accounting module an indication that the user was referred by an affiliate website.

As such, the accounting module 224 can be further configured to with logic to calculate correct billing charges to a user based on promotional discounts, preferred status, etc. In one embodiment, a discount can be provided to a customer that is referred to the website by an affiliate website. Each affiliate website can provide a unique affiliate code that is associated with a specific discount. Thus, for example, a user that was referred by a first affiliate may receive a lower per-minute rate than a user that was referred by a second affiliate.

While the apparatus and method have been described in terms of what are presently considered to be the most practical and preferred embodiments, it is understood that the disclosure need not be limited to the disclosed embodiments. It is intended to cover various modifications and similar arrangements included within the spirit and scope of the claims, the scope of which should be accorded the broadest possible interpretation so as to encompass all such modifications and similar structures. The present disclosure includes any and all embodiments of the following claims.

1. A method of providing a language interpretation service, comprising:
receiving from a user at a computing device a request for language interpretation service, wherein the user speaks a first language;
generating a user identifier that is associated to the user;
transmitting the user identifier to the computing device, the user identifier permitting access to language interpretation service;
providing a language access number, wherein the language access number can be used to place a voice call to a language interpretation service provider for language interpretation assistance;
receiving a voice call from the user, wherein the user places the voice call by dialing the language access number; and
providing language interpretation service to the user if the user provides the user identifier, wherein the language interpretation service interprets between the first language and a second language.

2. The method of claim 1, wherein the user identifier is stored in a user database.

3. The method of claim 1, further comprising charging a total amount of money for the language interpretation service to the user.

4. The method of claim 3, wherein the total amount of money is charged to a credit card of the user.

5. The method of claim 3, wherein the total amount of money charged is based on a per-minute fee.

6. The method of claim 3, wherein the total amount of money charged is discounted if the user is referred the language interpretation provider by a referring website.

7. The method of claim 1, wherein the request for language interpretation service includes user payment information.

8. The method of claim 7, wherein the user payment information includes user credit card information.

9. The method of claim 8, wherein the request for language interpretation service includes user personal information.

10. The method of claim 9, wherein the user personal information includes user preferences.

11. The method of claim 1, wherein the request for language interpretation is received at a registration server communicably coupled with the computing device through a computer network.

12. The method of claim 11, wherein the computer network is the Internet.

13. The method of claim 1, wherein the request is received by a live operator.

14. The method of claim 1, wherein the registration server is a web server that hosts a web page for entering data.

15. The method of claim 1, wherein the user identifier is associated with a user profile.

16. The method of claim 15, wherein the user profile includes user preferences.

17. The method of claim 16, wherein user preferences include the language spoken by the user.

18. The method of claim 16, wherein user preferences include the language to be translated.

19. The method of claim 1, wherein the language access number is a toll-free number.

20. The method of claim 1, further comprising identifying an interpreter that can translate between the first language and a second language.

21. The method of claim 1, wherein the language interpretation is provided to the user by engaging an interpreter in the voice call with the user.

22. The method of claim 1, further comprising identifying the type of business need of the user.

23. The method of claim 22, further comprising identifying a merchant that can address the business need of the user.

24. The method of claim 23, wherein the merchant is a bank, a health care provider, a government entity, an airline, a rental car agency, a hotel, a travel agency, an amusement park, a resort, a casino, a cruise line, a public transportation agency, a financial company, an insurance company, or a telecommunications company.

25. The method of claim 1, wherein the voice call is first received by a private branch exchange that routes the voice call to the interpreter, the interpreter being located remotely from the business facilities of the language interpretation service provider.

26. The method of claim 1, wherein the first language is English, Spanish, German, French or Chinese.

27. The method of claim 1, wherein the second language is English, Spanish, German, or French or Chinese.

28. A system of providing a language interpretation service, comprising:
a web server that receives from a user at a computing device a request for language interpretation service, the web server configured to transmit a user identifier to the computing device, wherein the user identifier permits access to language interpretation service;
a private branch exchange that receives a voice call from the user, wherein the user places the voice call by dialing a language access number, wherein the voice call is made to a language interpretation service provider to receive language interpretation service; and
a validation module that validates the user identifier, wherein if the validation module validates the user identifier the language interpretation service provider interprets between the user's language and an interpreted language.

29. The system of claim 28, further comprising a user database that stores the user identifier.

30. The system of claim 28, further comprising an accounting module that charges a total amount of money for the language interpretation service to the user.

31. The system of claim 30, wherein the total amount of money is charged to a credit card of the user.

32. The system of claim 30, wherein the total amount of money charged is based on a per-minute fee.

33. The system of claim 28, wherein the total amount of money charged is discounted if the user is referred the language interpretation provider by a referring website.

34. The system of claim 28, wherein the request for language interpretation service includes user payment information.

35. The system of claim 34, wherein the user payment information includes user credit card information.

36. The system of claim 28, wherein the request for language interpretation service includes user personal information.

37. The system of claim 36, wherein the user personal information includes user preferences.

38. The system of claim 28, wherein the web server is communicably coupled with the computing device through the Internet.

39. The system of claim 28, wherein the user identifier is associated with a user profile.

40. The system of claim 39, wherein the user profile includes user preferences.

41. The system of claim 40, wherein user preferences include the language spoken by the user.

42. The system of claim 40, wherein user preferences include the language to be translated.

43. The system of claim 28, wherein the language access number is a toll-free number.

44. The system of claim 28, wherein the language interpretation is provided to the user by engaging an interpreter in the voice call with the user.

45. The system of claim 28, wherein the private branch exchange routes the voice call to the interpreter, the interpreter being located remotely from the business facilities of the language interpretation service provider.

46. The system of claim 28, wherein the user's language is English, Spanish, German, French of Chinese.

47. The system of claim 28, wherein the interpreted language is English, Spanish, German, or French of Chinese.
